(19) United States
(12) Patent Application Publication
(10) Pub. No.: US 2007/0227294 A1
(43) Pub. Date: Oct. 4, 2007

(54) Bicycle crank arm assembly and related elements

(75) Inventor: Maurizio Valle, Vicenza (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.l., Vicenza (IT)

(21) Appl. No.: 11/717,398

(22) Filed: Mar. 13, 2007

(30) Foreign Application Priority Data
Mar. 29, 2006 (EP) 06425219.0

(51) Int. Cl. G05G 1/14

(52) U.S. Cl. 74/594.1

(57) ABSTRACT

A bicycle crank arm assembly is disclosed, comprising a crank arm having a first end for coupling with a bottom bracket assembly and a second end for coupling with a pedal, at least one of the first end and the second end comprising a hole extending from a side of the crank arm for coupling with an axle of the pedal or of the bottom bracket assembly, respectively, further comprising a reinforcing element extending around the hole at the side of the crank arm, and constrained to the crank arm.

### FIELD OF INVENTION

The present invention refers to a bicycle crank arm assembly, a crank arm, and a reinforcing element for a bicycle crank arm.

### BACKGROUND

Bicycle crank arms have a hole for receiving an axle of the pedal or respectively of the bottom bracket assembly. The hole is typically threaded or in any case includes a non-smooth wall to prevent the mutual rotation between the crank arm and the axle, for example it has a polygonal cross-section, in particular square or hexagonal, or else it is a cylindrical or conical hole having grooves or protrusions.

The problem with the known crank arms is that they easily brake in the hole areas, therefore an improved crank arm is needed.

### SUMMARY

The invention concerns, in a first aspect thereof, a bicycle crank arm assembly comprising a crank arm having a first end for coupling with a bottom bracket assembly and a second end for coupling with a pedal, at least one of the first end and the second end comprising a hole extending from one side—distal or proximal, respectively—of the crank arm for coupling with an axle of the pedal or of the bottom bracket assembly, respectively, further comprising a reinforcing element or washer extending around the hole at the side of the crank arm, and constrained to the crank arm.

In a second aspect thereof, the invention concerns a bicycle crank arm having a first end for coupling with an axle of the bottom bracket assembly and a second end for coupling with a pedal, at least one of the first end and the second end comprising a hole extending from one side—distal or proximal, respectively—of the crank arm for coupling with an axle of the pedal or of the bottom bracket assembly, respectively, comprising, at the side, a seat for a reinforcing element extending around the hole.

In a third aspect thereof, the invention concerns a reinforcing element comprising a flat circular body having an eccentric hole.

### BRIEF DESCRIPTION OF THE DRAWING(S)

Further characteristics and advantages of the present invention shall become clearer from the following detailed description of some preferred embodiments thereof, made with reference to the attached drawings, purely as a non-limiting example. In the drawings:

FIG. 1 is a partially sectional side view of a crank arm assembly according to the present invention coupled with the axle of a pedal;

FIG. 2 is an enlarged cross-section of a part of the coupling area between the crank arm assembly and the axle of FIG. 1;

FIG. 3 is an enlarged cross-section of a part of the pedal coupling area of the crank arm assembly of FIG. 1, wherein the forces acting on a reinforcing element thereof are schematically shown;

FIG. 4A is a plan view of the crank arm of the crank arm assembly of FIG. 1, wherein the forces acting on the reinforcing element are schematically shown;

FIG. 4B is a partial exploded view of the crank arm and washer of the crank arm assembly of FIG. 1;

FIG. 5 is a cross-section of the pedal coupling area of a crank arm assembly according to another embodiment of the present invention;

FIG. 6 is a cross-section of the pedal coupling area of a crank arm assembly according to another embodiment of the present invention;

FIG. 7 is an enlarged cross-section of the coupling area between the washer and the crank arm of the crank arm assembly of FIG. 6;

FIGS. 8 to 17 are sections of the pedal coupling area of crank arm assemblies according to other embodiments of the present invention;

FIG. 18 is a cross-section of the pedal coupling area of a crank arm assembly according to another embodiment of the present invention, wherein the interface surfaces between the crank arm and the washer have a different extent at different angular positions;

FIG. 19 is a plan view of the crank arm of the crank arm assembly of FIG. 18;

FIGS. 20 to 22 are sections of the pedal coupling area of crank arm assemblies according to other embodiments of the present invention, wherein the interface surfaces between the crank arm and the washer have a different extent at different angular positions; and

FIG. 23 is a partial perspective view of a crank arm assembly according to another embodiment of the present invention.

### DETAILED DESCRIPTION OF THE PREFERRED EMBODIMENT(S)

Introduction

The invention concerns, in a first aspect thereof, a bicycle crank arm assembly comprising a crank arm having a first end for coupling with a bottom bracket assembly and a second end for coupling with a pedal, at least one of the first end and the second end comprising a hole extending from one side—distal or proximal, respectively—of the crank arm for coupling with an axle of the pedal or of the bottom bracket assembly, respectively, further comprising a reinforcing element or washer extending around the hole at the side of the crank arm, and constrained to the crank arm.

Applicant has perceived that the main cause of fatigue breaking of the crank arms is tensile stress that occurs in the area around the hole when the cyclist pushes on the pedals.

Applicant has also noted that the maximum tensile stress occurs in the surface area of the hole, on the side from which the axle of the pedal or of the bottom bracket assembly protrudes.

In the crank arm assembly according to the invention, due to the constraint between the crank arm and the reinforcing element, the latter is able to absorb a large part of the stresses in the surface area of the hole, straining with the crank arm and taking the load off the crank arm. In this manner, the residual tensile stress in the crank arm is no longer enough to start and propagate the fractures at the direction changes of the surface of the hole.

Typically, the surface of the hole, at least in the portion near to the reinforcing element, is a surface with a non-smooth wall. The axle is thus effectively held at least in the area of maximum stress.

Preferably, the reinforcing element has a portion configured to receive an abutment portion of the axle resting against it.

In the direction of the axis of the hole, the reinforcing element, preferably, has a shorter extent than that of the hole, more preferably less than half the extent of the hole, and even more preferably less than a fifth of the extent of the hole. In this manner, the overall weight of the crank arm is reduced.

In a particularly preferred way, in the direction of the axis of the hole the reinforcing element has an extent comprised between one pitch of an inner threading of the hole and twice the pitch.

According to a particularly preferred characteristic of the crank arm assembly of the present invention, the reinforcing element has a greater modulus of elasticity than that of the crank arm, so that it is able to absorb a substantial portion of tensile stress of the crank arm.

Preferably, but not limited thereto, the material used to make the reinforcing element with the desired modulus of elasticity is selected from among steel, titanium alloy, and aluminum alloy.

The constraint can comprise the gluing of the reinforcing element to the crank arm. The crank arm can comprise a protruding seat for housing the reinforcing element. Preferably, the crank arm can comprise a recessed seat for housing the reinforcing element. The constraint can comprise, as an alternative or in addition to gluing, a caulking, in particular a caulking of the crank arm and/or of the reinforcing element around the recessed or protruding seat for the reinforcing element.

When the crank arm is made from a composite material, the constraint can, as an alternative or in addition to gluing, be accomplished by co-molding of the reinforcing element in the crank arm.

Alternatively, the reinforcing element is not housed in a seat of the crank arm, rather it is constrained onto the outer surface of the side of the crank arm.

Preferably, the crank arm and the reinforcing element are in contact along a respective interface surface not entirely contained in a plane transversal to an axis of the hole.

Preferably, the interface surfaces have an overall sloping progression with respect to the axis, so that the forces exerted by the crank arm onto the washer due to the constraint are more distributed in the body of the reinforcing element.

In the present description and in the attached claims, “overall sloping progression” indicates interface surfaces that can locally depart from a conical surface.

In first embodiments, the interface surfaces are conical surfaces. In this case, the forces transmitted from the crank arm to the washer act upon many planes perpendicular to the axis and continually arranged one adjacent to the other, substantially for the entire extent of the interface region between the crank arm and the washer. The constraint is therefore exerted uniformly throughout the body of the reinforcing element.

Preferably, the generating line of the conical surfaces is sloped with respect to a plane perpendicular to the axis by an angle comprised between 5° and 45°, and most preferably between 25° and 35°.

In order to increase the area of the interface surfaces between the crank arm and the washer, and therefore the constraint forces in particular in the case of gluing, the interface surfaces can be rotational surfaces having a curvilinear generating line with two or more inflexion points,: rotational surfaces having a curvilinear generating line with one inflexion point, rotational surfaces having a generating line shaped as an arc of circumference, rotational surfaces having a stepped generating line, or other surfaces, for example, deriving from a combination of the above.

The interface surfaces between the crank arm and the washer can also not be rotational surfaces, for example, multi-faceted surfaces and preferably frustum of pyramid-shaped surfaces.

In the above embodiments as well as in others, the interface surface of the reinforcing element can overall converge towards the crank arm, and the interface surface of the crank arm can overall diverge towards the reinforcing element or, vice-versa, the interface surface of the reinforcing element can overall diverge towards the crank arm, and the interface surface of the crank arm can overall converge towards the reinforcing element.

The interface surfaces between the crank arm and the reinforcing element can have a different extent at different angular positions about the axis.

Since the force that the cyclist exerts on the pedal changes in strength during the pedaling cycle and, thus, as a function of the angular position of the crank arm assembly, with the above provision it is possible to modify the interface surfaces so as to increase the forces transmitted from the crank arm to the reinforcing element, in particular, in the case of gluing during the portion of the pedaling cycle when the greatest force is exerted compared to the portion of the pedaling cycle when the smallest force is exerted.

In another embodiment, the interface surfaces between the crank arm and the reinforcing element are eccentric surfaces with respect to the hole.

Preferably, in this case the axis of the interface surfaces is parallel to the axis of the hole and defines therewith a plane sloping with respect to a longitudinal center line of the crank arm by an angle comprised between 30° and 70°.

In yet another embodiment, the interface surfaces between the crank arm and the reinforcing element have a different slope at different angular positions about the axis.

In a second aspect thereof, the invention concerns a bicycle crank arm having a first end for coupling with an axle of the bottom bracket assembly and a second end for coupling with a pedal, at least one of the first end and the second end comprising a hole extending from one side—distal or proximal, respectively—of the crank arm for coupling with an axle of the pedal or of the bottom bracket assembly, respectively, comprising, at the side, a seat for a reinforcing element extending around the hole.

The seat is preferably a recessed seat communicating with the hole. Alternatively, the seat is a seat protruding from the crank arm. The seat preferably has a flat bottom and even more preferably has a cylindrical side wall that can be eccentric with respect to the axis of the hole.

In a third aspect thereof, the invention concerns a reinforcing element comprising a flat circular body having an eccentric hole.

Detailed Description

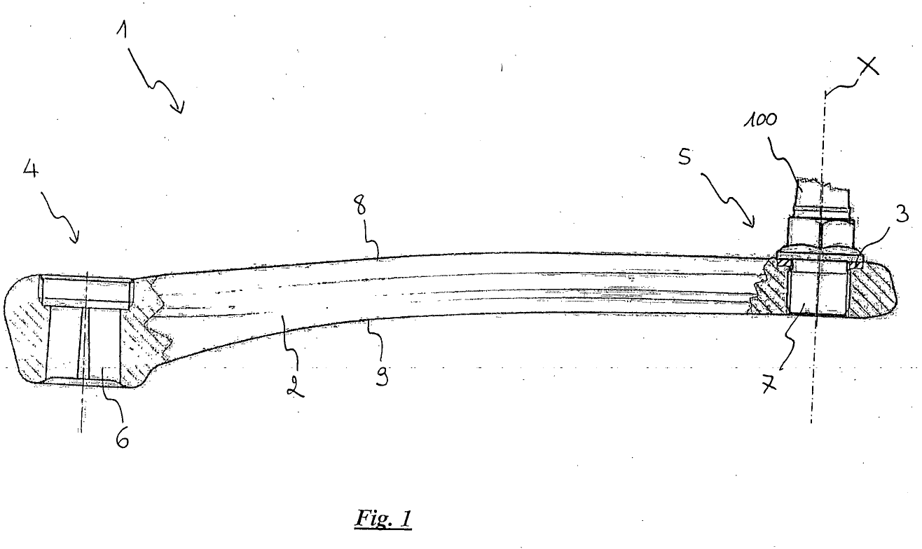

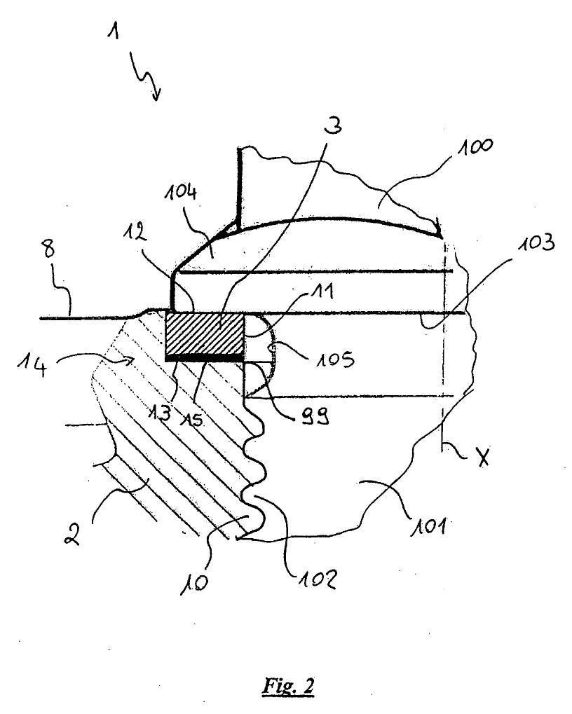

With reference to FIGS. 1 to 4B, a crank arm assembly 1 according to a first embodiment of the invention comprises a crank arm 2 and at least one reinforcing element or washer 3.

The crank arm 2 can be made from metallic material, typically light alloys like aluminum alloys, or from composite material. The composite material used preferably comprises structural fibers embedded in a polymeric material. Typically, the structural fibers are selected from the group consisting of carbon fibers, glass fibers, aramid fibers, ceramic fibers, boron fibers, and combinations thereof, carbon fibers being preferred. Preferably, the polymeric material of the crank arm is thermosetting, but it could be a thermoplastic material. More preferably, the polymeric material comprises an epoxy resin.

The washer 3 is made from a material with a greater modulus of elasticity than the modulus of elasticity of the material of the crank arm 2. For example, the modulus of elasticity of the material of the washer 3 may be about 60.000 N/mm² to 210.000 N/mm², and the modulus of elasticity of the material of the crank arm 2 may be about 5.000 N/mm² to 80.000 N/mm². Preferably, the washer 3 is metallic and, even more preferably it is made from a material selected from among steel, titanium alloys, and aluminum alloys. Of course, in an extreme case it is possible to have both the crank arm and the washer made of aluminum alloy. However, in this case the former will be made, for example, with an aluminum alloy having a modulus of elasticity of 69.000 N/mm² and the latter will be made, for example, with an aluminum alloy having a modulus of elasticity of 74.000 N/mm².

The crank arm 2 has a first end 4 for coupling with the axle of a bicycle bottom bracket assembly (not shown) and a second end 5 for coupling with an axle 100 of a pedal (not shown).

The first end 4 of the crank arm 2 comprises a hole 6 in which, during use of the crank arm, the axle of the bicycle bottom bracket assembly (not shown) is inserted.

The second end 5 of the crank arm 2 comprises a hole 7, having an axis X, in which, during use of the crank arm, the axle 100 is inserted. The hole 7 extends in the body of the crank arm 2 from the distal side 8 of the crank arm 2, with reference to the centre of the bicycle. In the illustrated embodiment, the hole 7 extends up to the proximal side 9 of the body of the crank arm 2, with reference to the center of the bicycle. In other words, in the illustrated embodiment, the hole 7 is a through hole made in the crank arm 2, but, in alternative embodiments, it could be a blind hole.

The hole 7 of the illustrated embodiment is a cylindrical hole having an internal threading 10 having a pitch P, but it could alternatively be a hole with a polygonal, in particular square or hexagonal, cross-section, a cylindrical or conical hole having grooves or protrusions, or a hole configured in another way to prevent the mutual rotation of the axle 100 and of the crank arm 2 about axis X, at least in a portion in the proximity of the first side 8 of the crank arm 2 and therefore in the proximity of the washer 3.

The washer 3 extends around the hole 7 at the distal side 8 of the crank arm 2. More specifically, the washer 3 is positioned close to the edge 99 of the hole 7. The washer 3 has a hole 11 of a shape and size matching the cross-section of the hole 7 of the crank arm 2, or such as to include it, to allow the insertion of the axle 100. The hole 11 has an axis coinciding with axis X, and is preferably defined by a smooth surface, for example a cylindrical surface. The washer 3 has a first substantially flat surface 12 and a second substantially flat surface 13 opposite surface 12.

The crank arm 2 has a recessed seat 14 of a shape matching the shape of the washer 3 for receiving the washer 3.

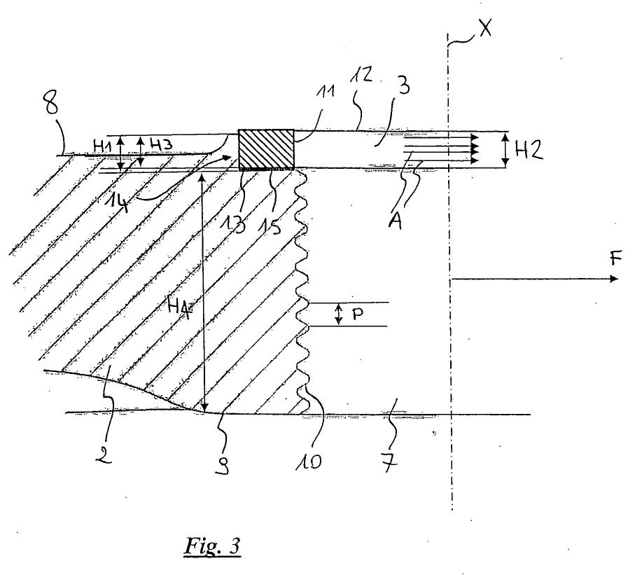

In the direction of axis X, the seat 14 of the crank arm 2 has an extent (i.e., depth) H1 and the washer 3 has an extent (i.e., thickness) H2, the contact zone between the crank arm 2 and the washer 3 has an extent (i.e., height) H3 and the hole 7 has an extent (i.e., depth) H4. It should be noted that, although in FIG. 3 the washer 3 slightly protrudes outside of the seat 14, it could alternatively be flush with the outer edge of the seat 14 and, thus, H3 would be substantially equal to H2 apart from the thickness of the layer of glue 15. Alternatively, the washer 3 could be housed beneath the outer edge of the seat 14.

The extents H1, H2, and H3 are preferably less than the extent H4 of the hole 7, more preferably less than half the extent H4 of the hole 7, even more preferably less than one fifth of the extent H4. Moreover, in the most preferred embodiment, the extents H1, H2, and H3 are comprised between one and two pitches P of the threading 10 of the hole 7.

Between the crank arm 2 and the washer 3, at least at the second surface 13 of the washer 3, a layer of glue 15 is arranged, which constrains the washer 3 to the crank arm 2.

As stated, in use a pedal is coupled with the crank arm assembly 1 through the axle 100. The axle 100 has an end portion 101 configured for passing in the hole 11 of the washer 3 and for coupling in the hole 7 of the crank arm 2.

In the illustrated embodiment, the end portion 101 of the axle 100 has a threading 102 matching the internal threading 10 of the hole 7 of the crank arm 2. In other embodiments the end portion 101 of the axle 100 could have a polygonal cross-section or could be equipped with ridges or grooves, matching the cross-section of the hole 7 of the crank arm 2. The axle 100 also has an abutment surface 103, typically made in a flange 104 thereof.

It should be noted that in the illustrated embodiment, the axle 100 also has a peripheral throat 105 arranged between the abutment surface 103 and the end portion 101, so that the inner wall of the hole 11 of the washer 3 does not contact the axle 100. Alternative embodiments do not include the throat 105, thereby allowing the inner wall of the hole 11 of the washer 3 to contact the axle 100.

When the end portion 101 of the axle 100 is screwed into the hole 7 of the crank arm 2, the abutment surface 103 abuts the substantially flat surface 12 of the washer 3.

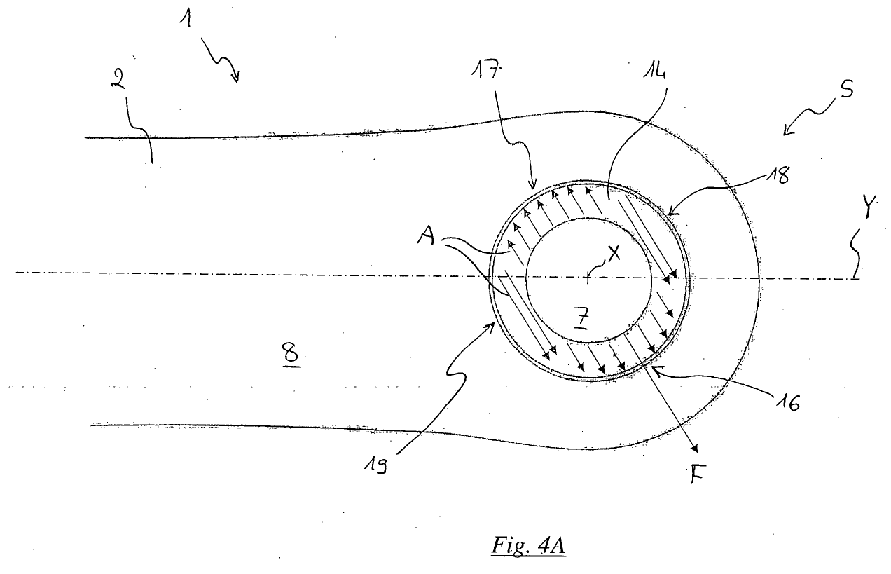

In use of the bicycle, when the cyclist pushes on the pedals, the axle 100 further transmits a tensile force to the crank arm 2, at the hole 7. In the most critical condition, wherein the cyclist exerts the maximum thrust on the pedal, the longitudinal axis Y of the crank arm is sloping by about 45° with respect to the horizontal, with the second end 5 above the horizontal passing through the axle of the bottom bracket assembly, and the force exerted by the cyclist is transferred onto the crank arm 2 substantially in the direction of the arrow F illustrated in FIGS. 3 and 4A, sloping by about 45° with respect to the longitudinal center line Y of the crank arm 2. In the present description, for the sake of simplicity, the force component in the plane perpendicular to the middle plane of the crank arm 2 (plane perpendicular to the plane of FIG. 4A) and the moment of the force F or torque are neglected.

With reference to FIG. 4A, the region 16 of the second end 5 of the crank arm 2 adjacent to the force F is therefore subject to a tensile force, whereas the opposite region 17 with respect to the axis X of the hole 7 is not subject to any tensile force. The crank arm 2 is therefore subject to a tensile load, which tends to induce an elastic elongation at the regions 18 and 19 extending between the regions 16 and 17. In other words, the hole 7 of the crank arm 2 has, in use thereof, the tendency to “become oval.”

Due to the repeated load cycles during pedaling, there is the risk of cracks in the throats of the threading 10 of the hole 7 or of the other sharp direction changes of the wall of the hole 7, especially in the proximity of the distal side 8 of the crank arm 2, and of consequent breaking by fatigue of the crank arm 2.

The constraint between the crank arm 2 and the washer 3 obtained through the layer of glue 15 allows the washer 3 to strain or “become oval” together with the crank arm 2, and to absorb part of such a tensile force, reducing the aforementioned risks. Indeed, such a layer of glue 15 prevents the mutual sliding between the crank arm 2 and the washer 3. By means of the layer of glue 15, the crank arm 2 exerts forces on the washer 3 in the various directions of the arrows A. More specifically, in the regions 16, 18, and 19 the forces A draw the corresponding region of the washer 3 into elongation as a single piece with the crank arm 2, whereas in the region 17 the forces A hold the corresponding region of the washer 3, opposing its sliding on the crank arm 2.

In particular, due to the modulus of elasticity of the constituent material of the washer 3 that is greater than the modulus of elasticity of the constituent material of the crank arm 2, the washer 3 absorbs a substantial part of the tensile stress in the surface region of the hole 7. For example, the modulus of elasticity of the constituent material of the washer 3 may be about 60.000 N/mm² to 210.000 N/mm², and the modulus of elasticity of the constituent material of the crank arm 2 may be about 5.000 N/mm² to 80.000 N/mm².

FIG. 4B illustrates that the washer 3 is preferably continuous. More specifically, the washer 3 is continuous in form without splits or notches which would render it elastic and diminish its reinforcement action.

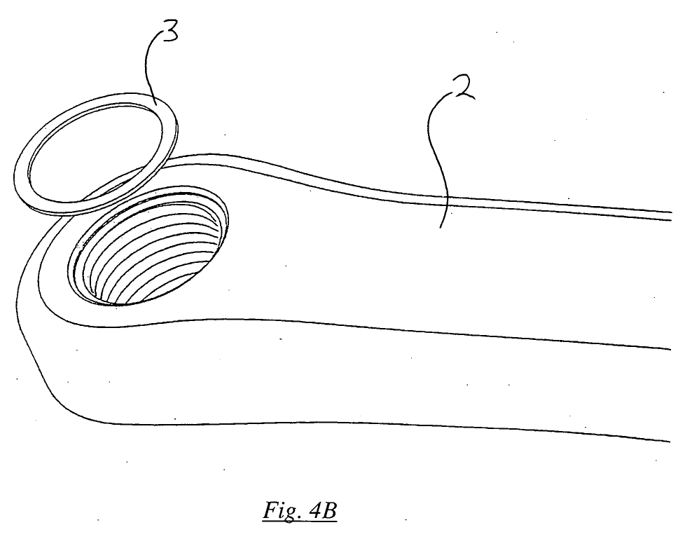

FIG. 5 illustrates an alternative in which the seat 14 for receiving the washer is missing and the washer 3 is glued to an external surface of the crank arm 2 at its hole 7. In the example of FIG. 5 the internal diameter d of the washer 3 is clearly greater than the major diameter D of the threading 10 of the hole 7 so as to allow the passage of the axle (not shown) without damaging its threading.

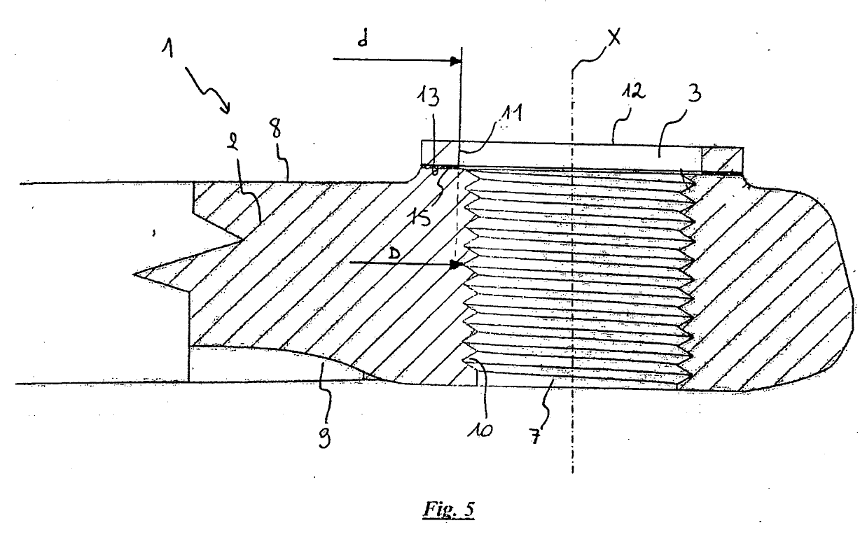

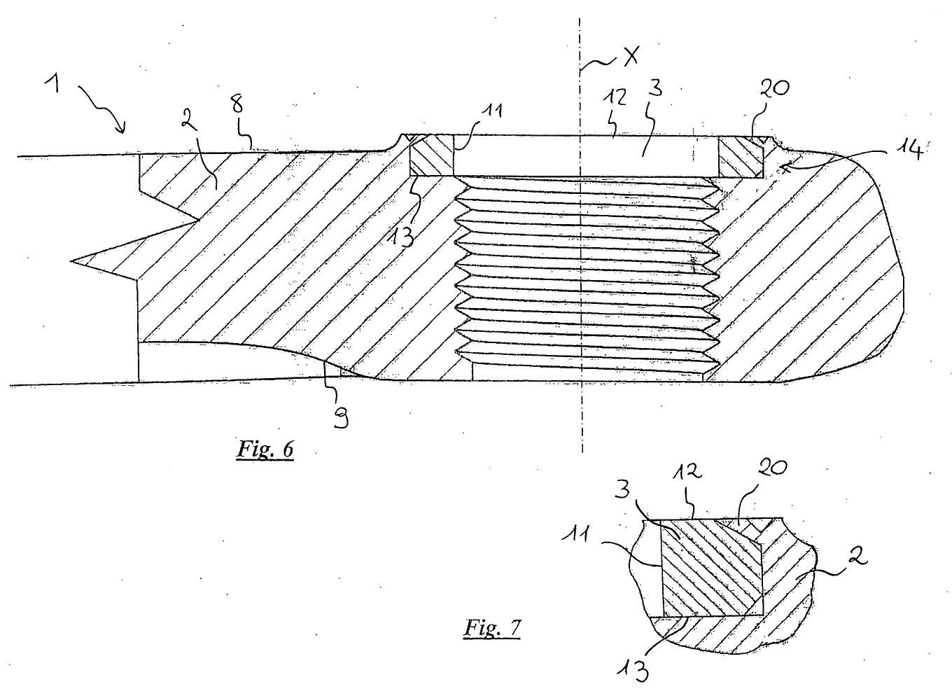

FIGS. 6 and 7 represent an alternative embodiment of the crank arm assembly 1, wherein the washer 3 is constrained to the crank arm 2 by caulking the crank arm 2 around the seat 14 for the washer 3, so that a part 20 of the material of the crank arm 2 partially covers the washer 3.

In a further embodiment (not shown), the constraint between the crank arm 2 and the washer 3 is accomplished both by caulking and by gluing.

When the crank arm is made from composite material, it is particularly simple to constrain the washer 3 to the crank arm 2 through co-molding. When the composite material of the crank arm 2 is cured it adheres to the washer 3 and prevents any relative mutual movement. In this case, the washer 3 can be held by means of the material of the crank arm 2 that partially covers the washer 3, similarly to the caulking material 20, or else through other projections or protrusions made in the side wall of the washer 3. The washer 3 can have alternative shapes to those described up to now.

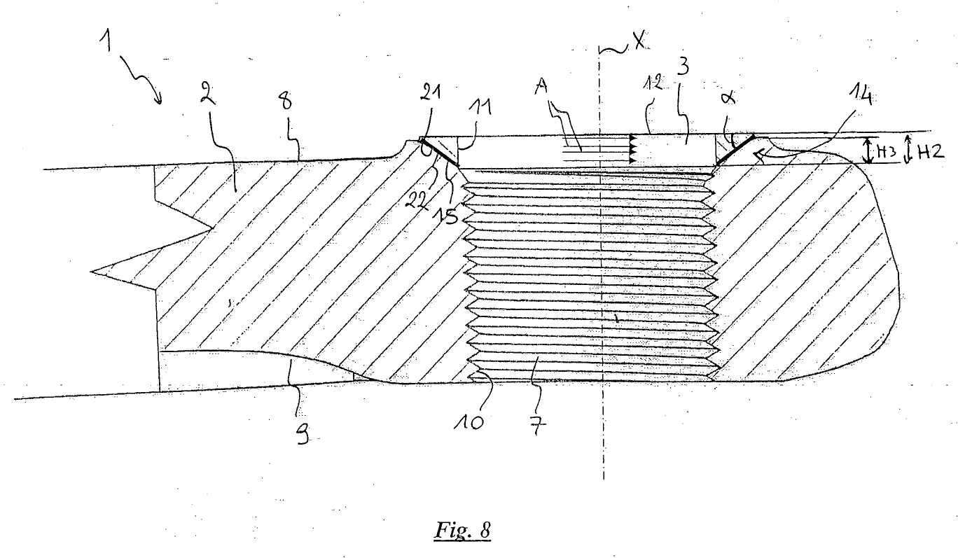

Thus, FIG. 8 illustrates an embodiment in which the second surface 21 of the washer 3, for interfacing with the crank arm 2, is a conical surface, having its axis coinciding with the axis X, and the seat 14 for receiving the washer 3 is of a shape matching the shape of the washer 3, in particular having a conical surface 22 for interfacing with the washer 3, with its axis coinciding with the axis X.

Preferably, the conical surface 22 of the seat 14 of the crank arm 2 and the conical surface 21 of the washer 2, respectively, are sloping with respect to a plane perpendicular to the axis X of the hole 7 of the crank arm 2 and of the hole 11 of the washer 3, respectively, by an angle α comprised between 5° and 45°, and even more preferably comprised between 25° and 35°.

As highlighted in FIG. 8, the forces A exerted by the crank arm 2 on the washer 3 through the layer of glue 15 during use of the crank arm assembly 1 act upon numerous planes perpendicular to the axis X, substantially for the entire extent H3 of the contact region between the crank arm 2 and the washer 3. The holding and the drawing into tension actions of the washer 3 are therefore distributed substantially along its entire extent H2 and therefore in its entire body, increasing the portion of tensile stress absorbed by the washer 3 itself.

Similarly, the change in the cross-section of the seat 14 spreads the stresses in the crank arm 2 over a greater region of material compared with the embodiments described above. The absolute value of the local stresses is therefore low.

Since the maximum values of the local stresses in the crank arm 2 are smaller, both because of their better distribution and because they are absorbed by the washer 3, the risk of cracks starting on the distal side 8 at the hole 7 is further reduced and, therefore, the fatigue lifetime of the crank arm 2 is increased.

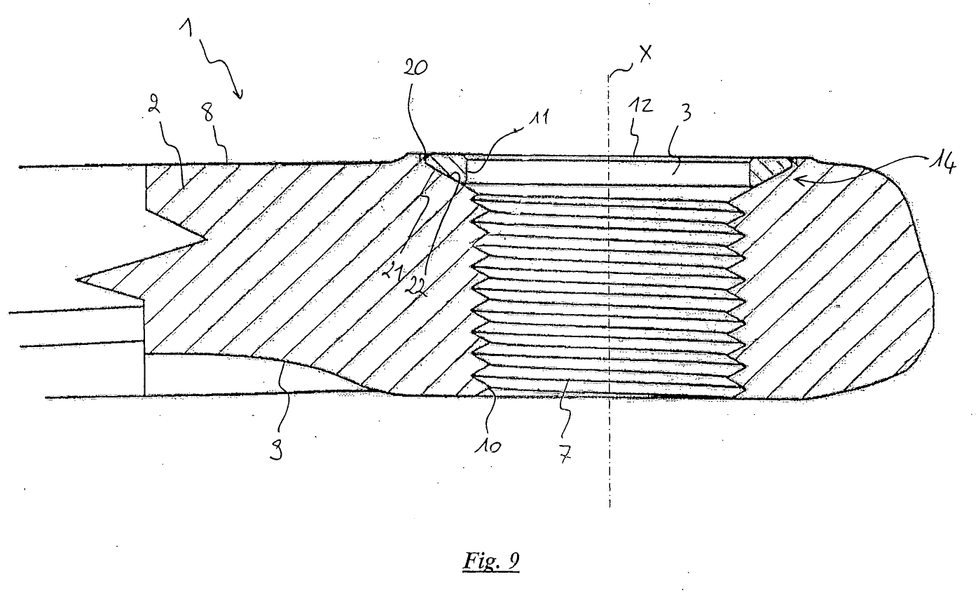

The embodiment of FIG. 9 differs from the embodiment of FIG. 8 in that the layer of glue 15 between the interface surfaces 21, 22 between the washer 3 and the crank arm 2 is replaced by caulking—or by co-molding—of the crank arm 2 around the seat 14 for the washer 3, so that a portion 20 of the material of the crank arm 2 partially covers the washer 3. Also in the case of conical interface surfaces 21, 22, the constraint between the crank arm 2 and the washer 3 can be accomplished both by caulking or co-molding, and by gluing.

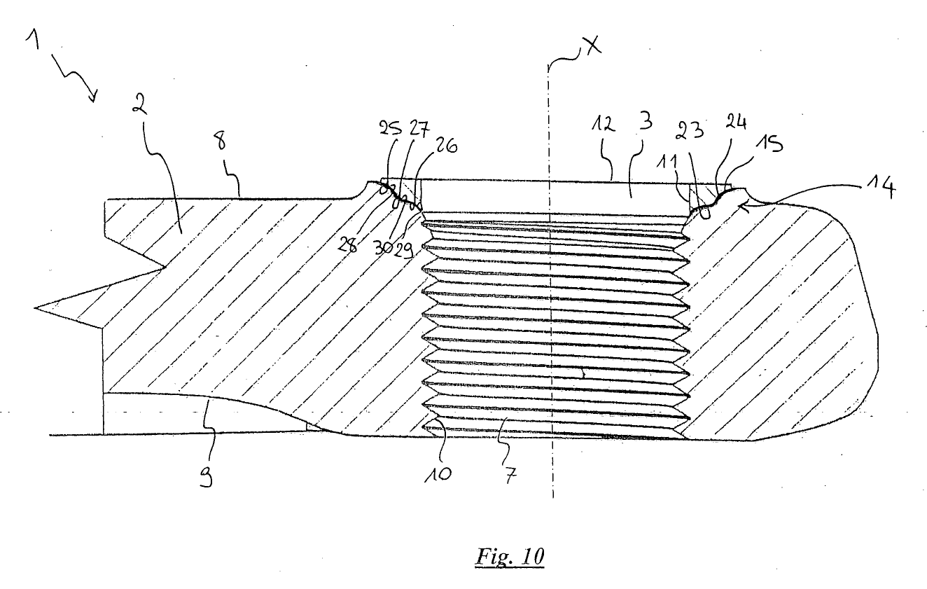

FIGS. 10 to 14 represent alternative embodiments of the crank arm assembly 1, wherein the interface surfaces between the crank arm 2 and the washer 3 are of increased area compared with the case of the embodiments described above and, therefore, the forces transmitted from the crank arm 2 to the washer 3, in particular in the case of gluing, are advantageously further increased. In these FIGS., the constraint is accomplished through gluing, but it could be accomplished, alternatively or in addition thereto, through caulking of the crank arm 2 or of the washer 3 around the seat 14 for the washer 3, or through co-molding.

In particular, FIG. 10 shows a crank arm assembly 1 wherein the interface surfaces 23, 24 of the washer 3 and of the crank arm 2, respectively, are rotational surfaces having a curvilinear generating line with two inflexion points. More specifically, the generating line of the interface surface 23 of the washer 3 has two concave portions 25, 26 and a convex portion 27 between them, and the generating line of the interface surface 24 of the crank arm 2 has two convex portions 28, 29 and a concave portion 30 between them. Mutual interface surfaces that are rotational surfaces with a generating line having more than two inflexion points can also be used.

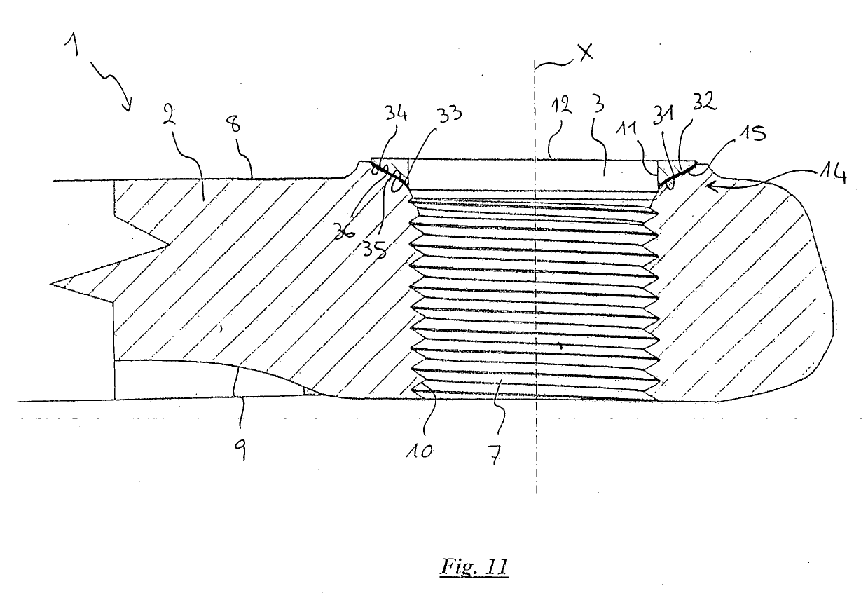

FIG. 11 shows a crank arm assembly 1 wherein the interface surfaces 31, 32 of the washer 3 and of the crank arm 2, respectively, are rotational surfaces having a curvilinear generating line with one inflexion point. More specifically, the generating line of the interface surface 31 of the washer 3 has a concave portion 33 and a convex portion 34, and the generating line of the interface surface 32 of the crank arm 2 has a convex portion 35 and a concave portion 36.

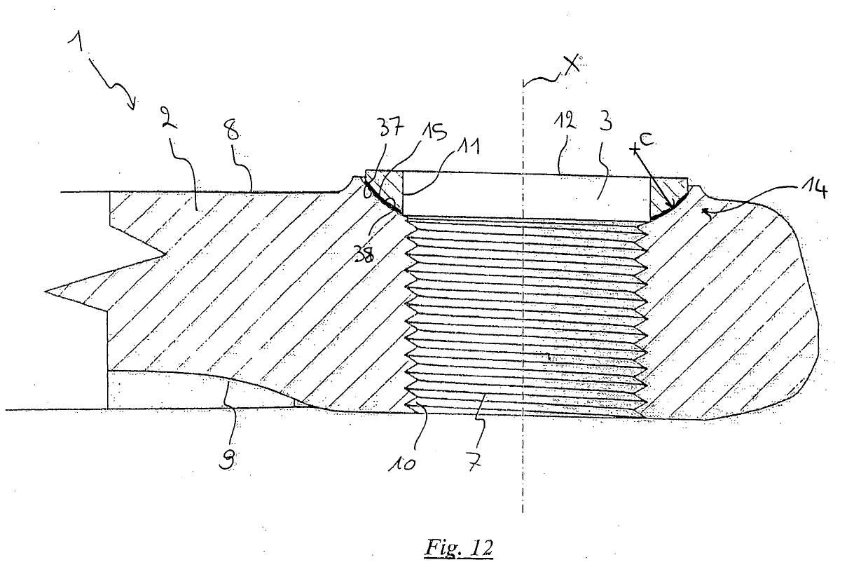

FIG. 12 shows a crank arm assembly 1 wherein the interface surfaces 37, 38 of the washer 3 and of the crank arm 2, respectively, are rotational surfaces having a generating line shaped as an arc of circumference. More specifically, the generating line of the interface surface 37 of the washer 3 is convex, and the generating line of the interface surface 38 of the crank arm 2 is concave. The center C of the arc of circumference does not lie on the axis X, but this possibility is also not ruled out, in which case the surfaces 37, 38 would be spherical.

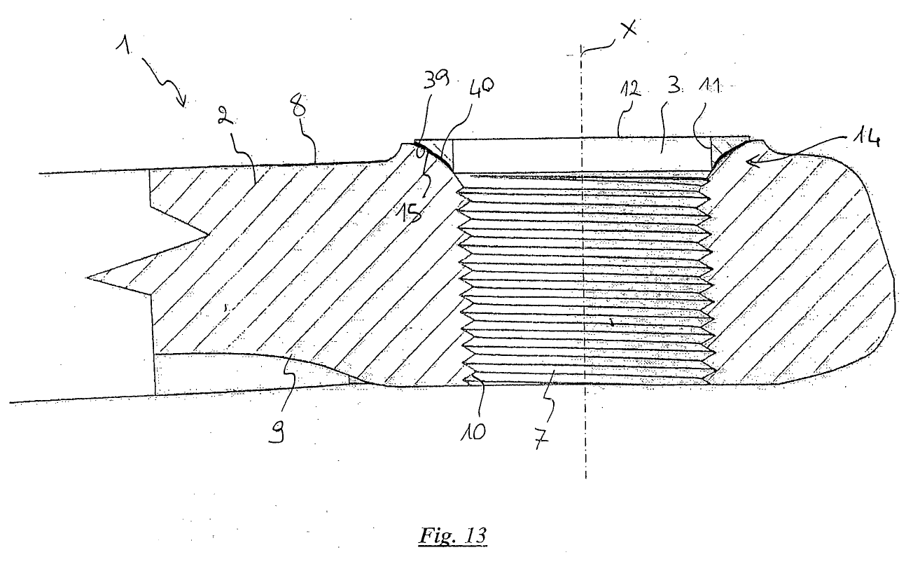

FIG. 13 also shows a crank arm assembly 1 wherein the interface surfaces 39, 40 of the washer 3 and of the crank arm 2, respectively, are rotational surfaces having a generating line shaped as an arc of circumference. In this case, the generating line of the interface surface 39 of the washer 3 is concave and the generating line of the interface surface 40 of the crank arm 2 is convex.

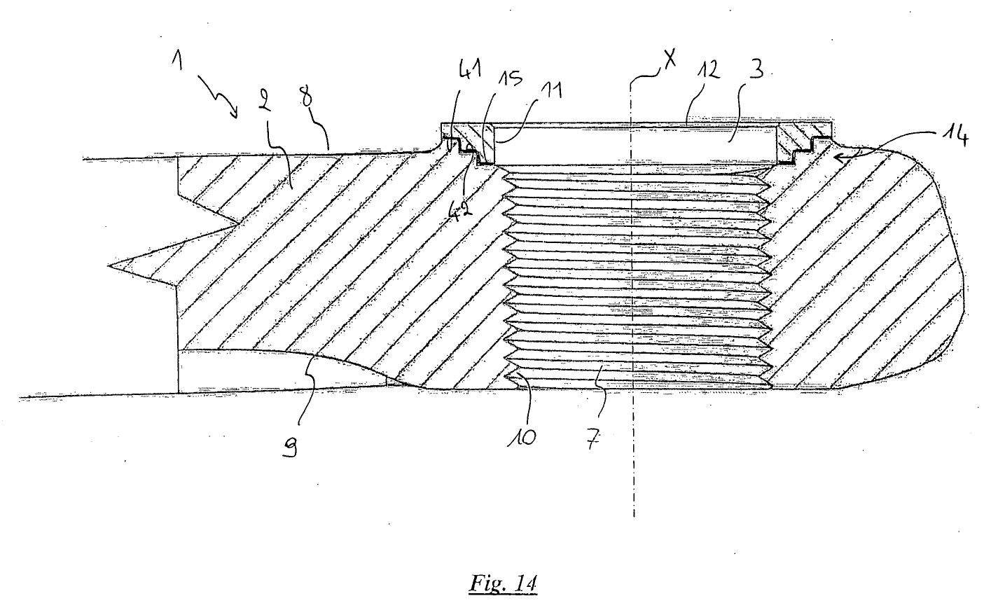

FIG. 14 shows a crank arm assembly 1 wherein the interface surfaces 41, 42 of the crank arm 2 and of the washer 3, respectively, are rotational surfaces having a stepped generating line. Although three steps are illustrated, rotational surfaces having a generating line with two, four, or more steps can be used.

In the embodiments of FIGS. 8 to 14, the interface surfaces between the crank arm 2 and the washer 3 have an overall sloping progression with respect to the axis X of the hole 7. More specifically, the interface surface of the washer 3 overall converges towards the crank arm 2 and the interface surface of the crank arm 2 overall diverges towards the washer 3.

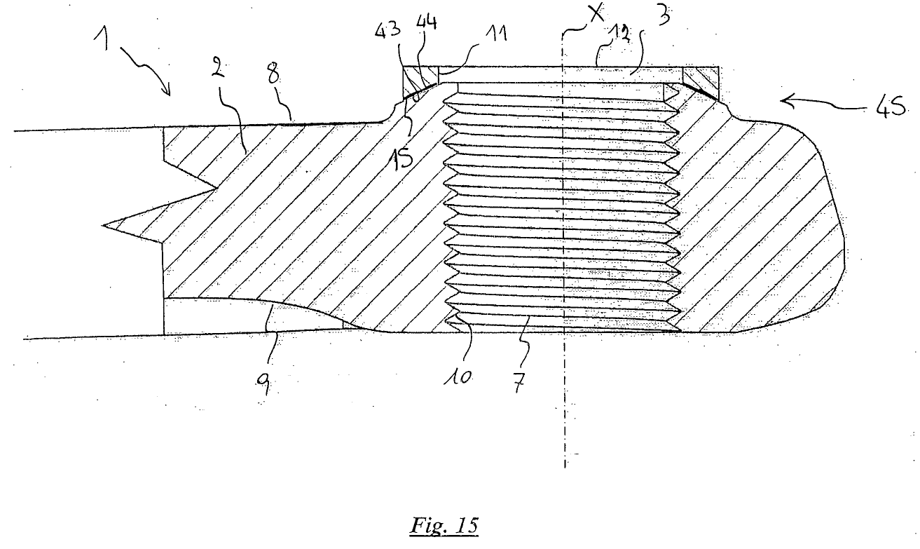

FIG. 15 shows a crank arm assembly 1 wherein the interface surfaces 43, 44 of the washer 3 and of the crank arm 2, respectively, have an overall sloping progression with respect to the axis X of the hole 7, but with opposite orientation with respect to the embodiments of FIGS. 8 to 14. In particular, the interface surface 43 of the washer 3 overall diverges towards the crank arm 2, and the interface surface 44 of the crank arm 2 overall converges towards the washer 3. The interface surfaces 43, 44 are more specifically conical, but they could alternatively be surfaces similar to those described above with reference to FIGS. 8 to 14.

The interface surface 44 of the crank arm 2 is also made in a seat 45 protruding from the distal side 8 of the crank arm 2. It should also be understood that in the other described embodiments, the seat 14 recessed into the crank arm 2 for receiving the washer 3 can be replaced by a protruding seat 45.

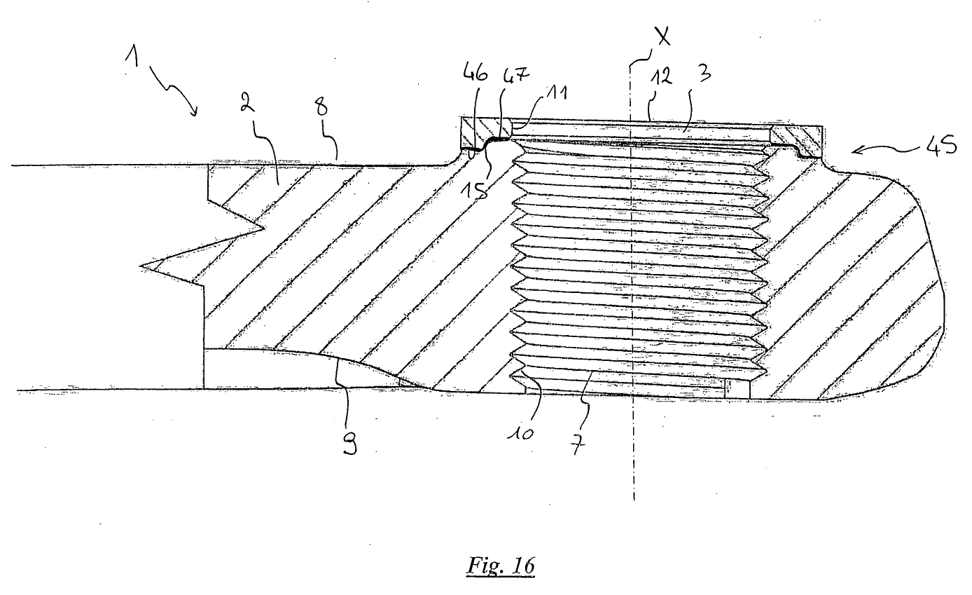

As a further example of the above, FIG. 16 shows a crank arm assembly 1 wherein the interface surfaces 46, 47 of the washer 3 and of the crank arm 2, respectively, are stepped, with an overall sloping progression with respect to the axis X of the hole 7, with the interface surface 46 of the washer 3 overall diverging towards the crank arm 2, and the interface surface 47 of the crank arm 2 overall converging towards the washer 3.

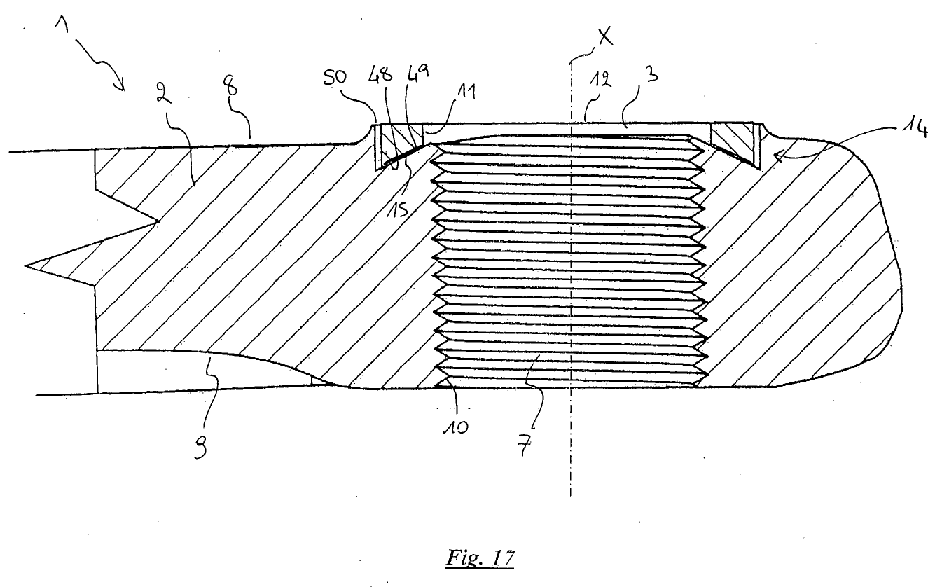

FIG. 17 shows a crank arm assembly 1 similar to the embodiment of FIG. 15, wherein the interface surface 48 of the washer 3 is conical diverging towards the crank arm 2, and the interface surface 49 of the crank arm 2 is conical converging towards the washer 3, but wherein the seat of the crank arm 2 for receiving the washer 3 is a recessed seat 14. In this case, as in the previous ones, the constraint can be obtained by caulking, gluing, co-molding, or similar systems.

The conical interface surface 49 of the crank arm 2 protrudes within the seat 14 and wedges into the flaring of the interface surface 48 of the washer 3. When the protrusion of the crank arm 2 expands because of the tensile stress of the axle 100 inserted in the hole 7, it places the washer 3 under further tensile stress by mechanical effect.

It should be noted that between the seat 14 of the crank arm 2 and the washer 3 there is an optional annular clearance 50.

In view of the fact that the force that the cyclist exerts on the pedal changes in strength during the pedaling cycle as a function of the angular position of the crank arm assembly 1, it is possible to modify the interface surfaces between the crank arm 2 and the washer 3 so as to increase the transmission of the forces A during the portion of the pedaling cycle when the greater force is exerted with respect to the portion of the pedaling cycle when the smallest force is exerted. This can be obtained by providing for the extent of the interface surfaces between the crank arm and the washer at different angular positions around the axis X to be different.

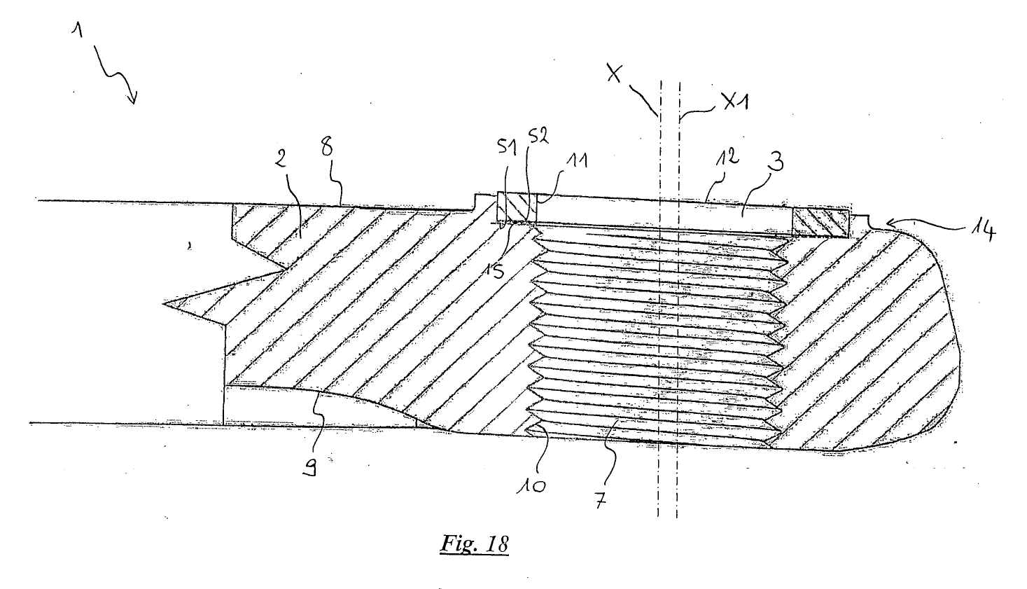

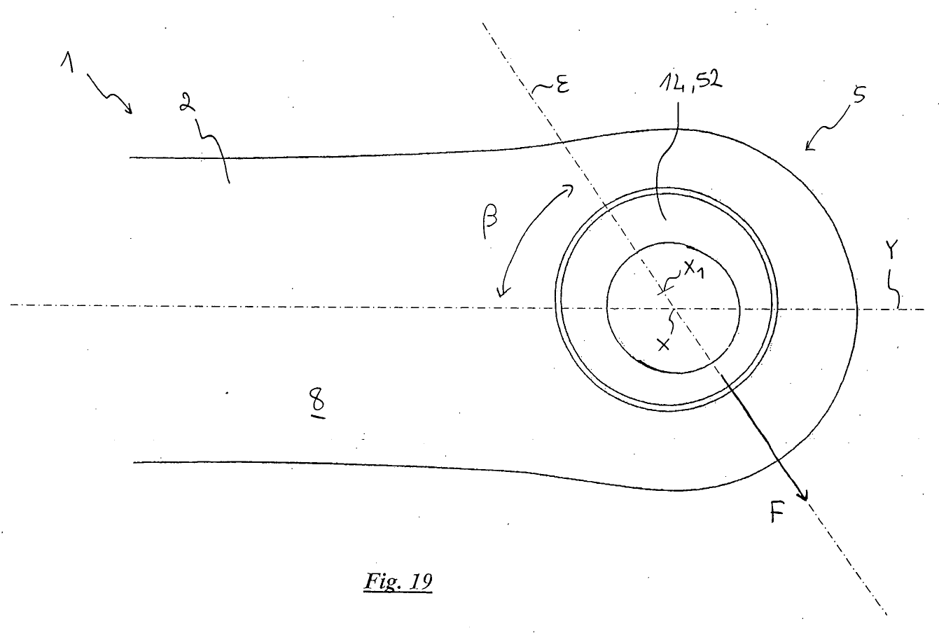

Thus, in the embodiment shown in FIGS. 18 and 19, the crank arm 2 has a recessed seat 14 for a flat circular washer 3. The washer 3 and the seat 14 are eccentric with respect to the hole 7 of the crank arm 2 and to the central hole 11 of the washer 2. The interface surface 51 of the washer 3 and the interface surface 52 of the crank arm 2 therefore have an annulus portion and a cylindrical portion. The axis X1 of the interface surfaces 51, 52 is preferably parallel to the axis X, and preferably defines, with the axis X, a plane ε sloping with respect to the longitudinal center line Y of the crank arm 2 by an angle β comprised between 30° and 70°.

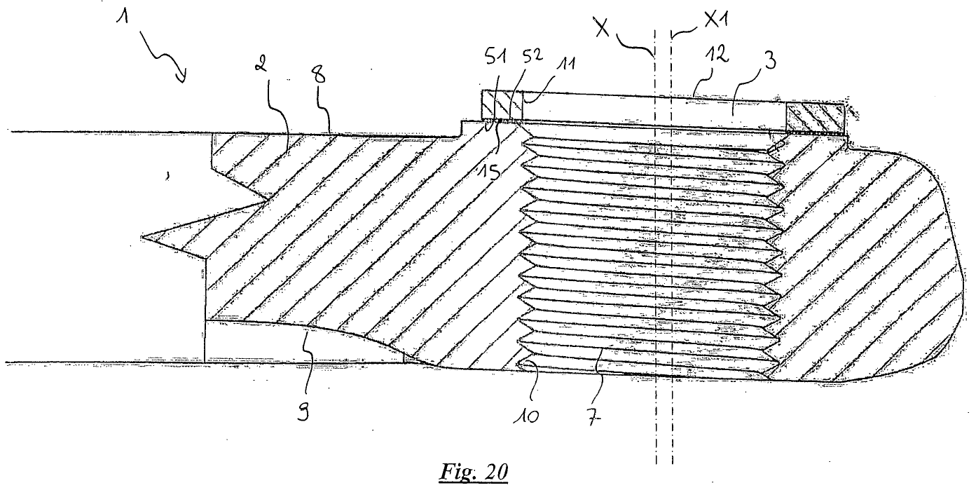

FIG. 20 shows a further example of interface surfaces between the crank arm 2 and the washer 3 with different areas as a function of the angular position. In particular, the crank arm assembly 1 differs from that of FIGS. 18 and 19 in that the washer 3 is glued to the outside of the crank arm 2. In other words, there is neither a recessed seat 14 nor a protruding seat 45.

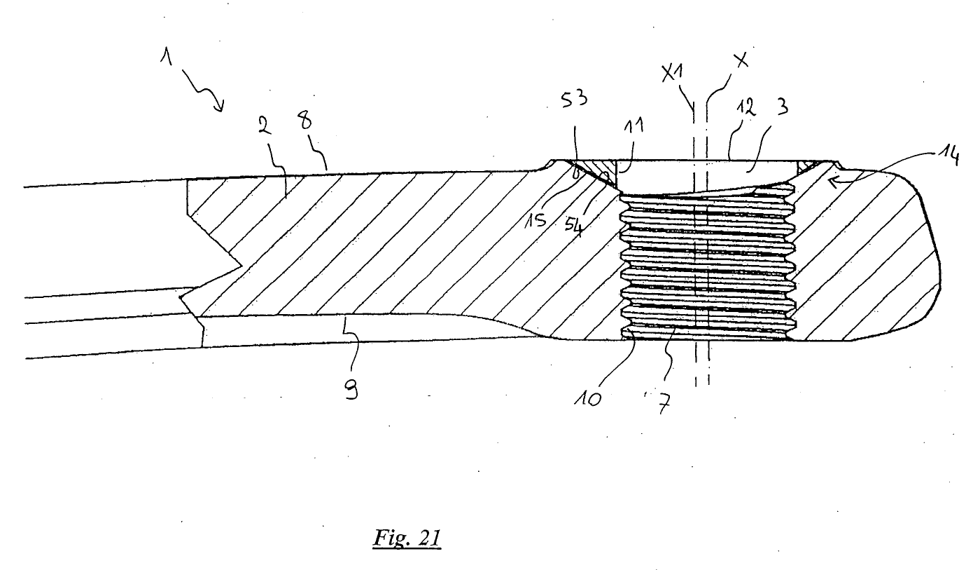

According to an alternative illustrated in FIG. 21, the interface surfaces 53 and 54 of the washer 3 and of the crank arm 2, respectively, are conical.

It will be understood that the other interface surfaces described above could also be made eccentric.

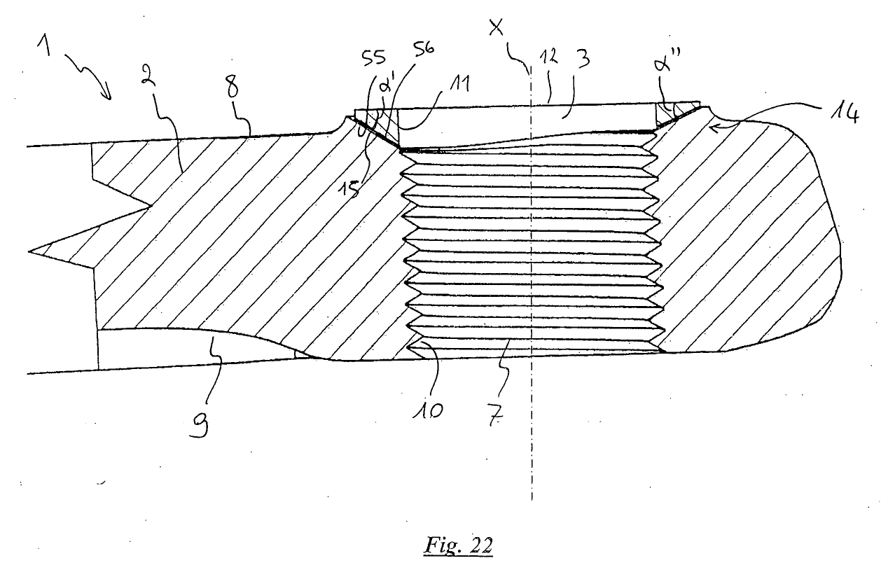

As a further example, in the embodiment shown in FIG. 22, the interface surface 55 of the washer 3 and the interface surface 56 of the crank arm 2 have variable slopes as a function of the angular position around the axis X. In FIG. 22 the two slopes a′ and a″ are identified at the two angular positions defined by the longitudinal axis Y of the crank arm 2.

The slope can vary, for example, between 5° and 45°, in a gradual manner all around the axis X. In an embodiment that is particularly simple to carry out, the interface surfaces 55, 56 with gradually variable slope are conical surfaces with sloping axes with respect to the axis X of the hole 7.

The slope of the surfaces 55, 56 can, however, vary also in sectors, or there can be a first sector that extends for a first predetermined arc of circumference with a minimum slope, a second sector that extends for a second predetermined arc of circumference with a maximum slope, and two joining sectors where the slope varies gradually, preferably linearly, between the minimum slope and the maximum slope.

Interface surfaces between the crank arm 2 and the washer 3 that are not rotational surfaces, i.e., that do not have circular symmetry like, for example, frustum of pyramid-shaped surfaces or more generally faceted surfaces, can be used. In this case, similar to the case of the embodiments of FIGS. 18 to 22, the mutual rotation between the crank arm 2 and the washer 3 about the axis X is also prevented.

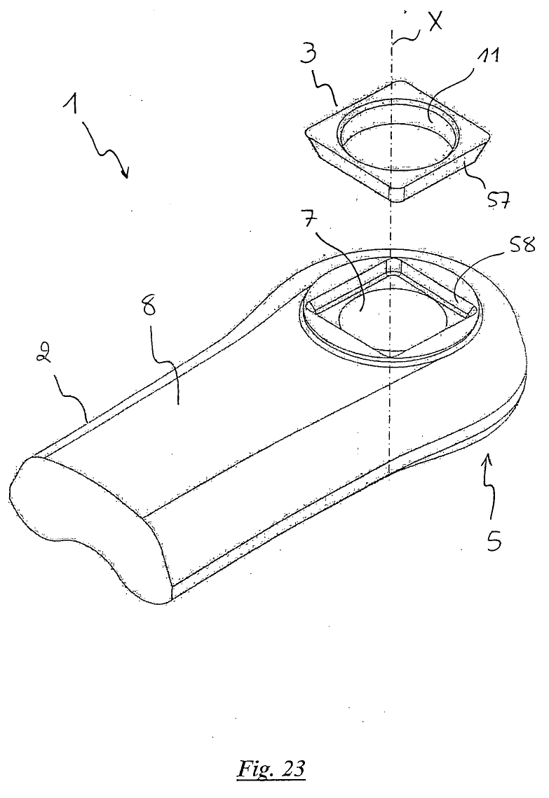

As an example, FIG. 23 shows a crank arm assembly 1 wherein the interface surfaces 57, 58 of the washer 3 and of the crank arm 2, respectively, are frustum of square pyramid-shaped surfaces, with smoothed edges. The base of the pyramid can have any number of sides; moreover, also in the case of multi-facetted or pyramid-shaped interface surfaces, the axis can be sloping and/or eccentric with respect to the axis X.

Moreover, in the various embodiments described above, the substantially flat surface 12 of the washer 3 and/or the abutment surface 103 of the axle 100 could be replaced by a knurled, grooved, or otherwise textured surface. Furthermore, the hole 11 of the washer 3 could be conical or more generically could have a divergent or convergent progression corresponding to the overall progression of its interface surface with the crank arm 2, so as to obtain a thinner washer 3, of advantageously less weight.

Those skilled in the art will also understand that what has been described and illustrated applies to the hole 6 for coupling with the axle of the bottom bracket assembly, as an alternative or in addition to the hole 7 for coupling with the pedal.

One or other of the hole 6 for coupling with the bottom bracket assembly axle and the hole 7 for coupling with the pedal can also be replaced by an axle made integrally with the crank arm, a hole being instead provided in the pedal or in the bottom bracket assembly, respectively.

What is claimed is:

1. A bicycle crank arm assembly comprising a crank arm having a first end for coupling with a bottom bracket assembly and a second end for coupling with a pedal, at least one of said first end and said second end defining a hole extending from a side of the crank arm for coupling with an axle of the pedal or of the bottom bracket assembly, respectively, further comprising a reinforcing element, extending around the hole at said side of the crank arm, and constrained to the crank arm.

2. Crank arm assembly according to claim 1, wherein the reinforcing element has a portion configured to receive an abutment portion of said axle resting upon it.

3. Crank arm assembly according to claim 1, wherein in the direction of an axis of the hole, the reinforcing element has a shorter extent than the extent of the hole.

4. Crank arm assembly according to claim 3, wherein in the direction of the axis, the reinforcing element has an extent of less than half the extent of the hole.

5. Crank arm assembly according to claim 4, wherein in the direction of the axis, the reinforcing element has an extent of less than one fifth of the extent of the hole.

6. Crank arm assembly according to claim 1, wherein in the direction of an axis of the hole, the reinforcing element has an extent comprised between one pitch of an internal threading of the hole and twice the pitch.

7. Crank arm assembly according to claim 1, wherein the reinforcing element has a greater modulus of elasticity than that of the crank arm.

8. Crank arm assembly according to claim 1, wherein the reinforcing element is made from a material selected among steel, titanium alloy, and aluminum alloy.

9. Crank arm assembly according to claim 1, wherein said constraint comprises gluing.

10. Crank arm assembly according to claim 1, wherein the crank arm comprises a protruding seat for housing the reinforcing element.

11. Crank arm assembly according to claim 1, wherein the crank arm comprises a recessed seat for housing the reinforcing element.

12. Crank arm assembly according to claim 1, wherein said constraint comprises a caulking.

13. Crank arm assembly according to claim 12, wherein said constraint comprises a caulking of the crank arm and/or of the reinforcing element around a seat for the reinforcing element.

14. Crank arm assembly according to claim 1, wherein the crank arm is made from a composite material and said constraint is accomplished by co-molding of the reinforcing element in said crank arm.

15. Crank arm assembly according to claim 1, wherein the reinforcing element is constrained onto the outer surface of the side of the crank arm.

16. Crank arm assembly according to claim 1, wherein the crank arm and the reinforcing element are in contact along a respective interface surface not entirely contained in a plane transversal to an axis of the hole.

17. Crank arm assembly according to claim 16, wherein the interface surfaces have an overall sloping progression with respect to the axis.

18. Crank arm assembly according to claim 17, wherein the interface surfaces are conical surfaces.

19. Crank arm assembly according to claim 18, wherein the generating line of the conical interface surfaces is sloping with respect to a plane perpendicular to the axis by an angle comprised between 5° and 45°.

20. Crank arm assembly according to claim 17, wherein the interface surfaces are rotational surfaces having a curvilinear generating line with at least two inflexion points.

21. Crank arm assembly according to claim 17, wherein the interface surfaces are rotational surfaces having a curvilinear generating line with one inflexion point.

22. Crank arm assembly according to claim 17, wherein the interface surfaces are rotational surfaces having a generating line shaped as an arc of circumference.

23. Crank arm assembly according to claim 17, wherein the interface surfaces are rotational surfaces having a stepped generating line.

24. Crank arm assembly according to claim 17, wherein the interface surfaces are multi-faceted.

25. Crank arm assembly according to claim 24, wherein the interface surfaces are frustum of pyramid-shaped surfaces.

26. Crank arm assembly according to claim 17, wherein the interface surface of the reinforcing element overall converges towards the crank arm, and the interface surface of the crank arm overall diverges towards the reinforcing element.

27. Crank arm assembly according to claim 17, wherein the interface surface of the reinforcing element overall diverges towards the crank arm, and the interface surface of the crank arm overall converges towards the reinforcing element.

28. Crank arm assembly according to claim 16, wherein the interface surfaces between the crank arm and the reinforcing element have a different extent at different angular positions about the axis.

29. Crank arm assembly according to claim 28, wherein the interface surfaces between the crank arm and the reinforcing element are eccentric surfaces with respect to the hole.

30. Crank arm assembly according to claim 29, wherein an axis of the interface surfaces is parallel to the axis, and defines, with the axis, a plane sloping with respect to a longitudinal center line of the crank arm by an angle comprised between 30° and 70°.

31. Crank arm assembly according to claim 28, wherein the interface surfaces between the crank arm and the reinforcing element have a different slope at different angular positions about the axis.

32. A bicycle crank arm having a first end for coupling with an axle of a bottom bracket assembly and a second end for coupling with a pedal, at least one of said first end and said second end defining a hole extending from a side of the crank arm for coupling with an axle of the pedal or respectively of the bottom bracket assembly, comprising, at said side, a seat for a reinforcing element extending around the hole.

33. Crank arm according to claim 32, wherein said seat is a recessed seat communicating with the hole.

34. Crank arm according to claim 32, wherein said seat is a seat protruding from the crank arm.

35. Crank arm according to claim 32, wherein the seat has a flat bottom.

36. Crank arm according to claim 32, wherein the seat has a cylindrical side wall.

37. Crank arm according to claim 36, wherein the cylindrical side wall is eccentric with respect to the axis of the hole.

38. Reinforcing element comprising a flat circular body having an eccentric hole.

39. A bicycle crank arm assembly comprising:
a crank arm comprising
a first end for coupling with a bottom bracket assembly, and
a second end for coupling with a pedal, at least one of said first end and said second end defining a hole extending from a side of the crank arm for coupling with an axle of the pedal or of the bottom bracket assembly, respectively; and
a reinforcing element extending around said hole at said side of the crank arm, and constrained to the crank arm,
wherein said crank arm and said reinforcing element are in contact along essentially conical mutual contact surfaces.

40. The bicycle crank arm assembly according to claim 39, wherein said crank arm comprises a recessed seat for housing said reinforcing element.

41. The bicycle crank arm assembly according to claim 39, wherein said constraint comprises a caulking.

42. The bicycle crank arm assembly according to claim 39, wherein said generating line of said conical interface surfaces is sloping with respect to a plane perpendicular to an axis of said hole by an angle comprised between 5° and 45°.

43. The bicycle crank arm assembly according to claim 39, wherein said reinforcing element comprises an annular shape.

44. The bicycle crank arm assembly according to claim 39, wherein the configuration of said reinforcing element is continuous around an axis of said hole.

45. The bicycle crank arm assembly according to claim 39, wherein in the direction of an axis of said hole, said reinforcing element has an extent comprised between one pitch of an internal threading of said hole and twice said pitch.

46. A bicycle crank arm assembly comprising:
a crank arm comprising
a first end for coupling with a bottom bracket assembly, and
a second end for coupling with a pedal, at least one of said first end and said second end defining a traverse hole for coupling with an axle of the pedal or of the bottom bracket assembly, respectively; and
a reinforcing element extending around said hole and constrained to the crank arm,
wherein said crank arm and said reinforcing element are in contact along a respective substantially conical interface surface.

47. A bicycle crank arm assembly comprising:
a crank arm comprising
a first end for coupling with a bottom bracket assembly,
a second end for coupling with a pedal, at least one of said first end and said second end defining a hole extending from a side of the crank arm for coupling with an axle of the pedal or of the bottom bracket assembly, respectively, and
a recessed seat; and
an annular-shaped reinforcing element continuously extending around said hole and housed within said recessed seat at said side of the crank arm, and constrained to the crank arm,
wherein said crank arm and said reinforcing element are in contact along a respective conical interface surface.

48. A bicycle crank arm assembly comprising:
a crank arm comprising
a first end for coupling with a bottom bracket assembly,
a second end for coupling with a pedal, at least one of said first end and said second end defining a traverse hole for coupling with an axle of the pedal or of the bottom bracket assembly, respectively, and
a recessed seat; and
an annular-shaped reinforcing element continuously extending around said hole and housed within said recessed seat and constrained to the crank arm,
wherein said crank arm and said reinforcing element are in contact along a respective substantially conical interface surface.

49. A bicycle crank arm assembly comprising:
a crank arm comprising
a first end for coupling with a bottom bracket assembly, and
a second end for coupling with a pedal, at least one of said first end and said second end defining a hole extending from a side of the crank arm for coupling with an axle of the pedal or of the bottom bracket assembly, respectively; and
a reinforcing element extending around said hole at said side of the crank arm, and constrained to the crank arm, the overall reinforced element being positioned in a zone close to the edge of the hole.

50. The bicycle crank arm assembly according to claim 49 wherein the reinforcing element embraces a free area with a cross section greater than a cross section of the hole close to the reinforced element.

51. The bicycle crank arm assembly according to claim 50 wherein the hole is defined by an internally threaded surface for coupling with a threading of the axle, while the reinforced element has a smooth surface facing the embraced free area.

52. A bicycle crank arm assembly comprising:
a crank arm comprising
a first end for coupling with a bottom bracket assembly axle, and
a second end for coupling with a pedal axle, at least one of said first end and said second end defining a hole for coupling with an axle of the pedal or of the bottom bracket assembly, respectively; and
a reinforcing element extending around said hole, and constrained to the crank arm, the reinforcing element embracing a free area with a cross section greater than a cross section of the hole close to the reinforced element.

53. Bicycle crank arm assembly comprising:
a crank arm comprising
a first end for coupling with a bottom bracket assembly and
a second end for coupling with a pedal, at least one of said first end and said second end defining a hole for coupling with an axle of the pedal or of the bottom bracket assembly, respectively; and
a reinforcing element, extending around the hole, and constrained to the crank arm, the reinforcing element having a portion configured for receiving an abutment portion of said axle resting upon it,
wherein the crank arm and the reinforcing element contact along a respective surface not entirely contained within a plane perpendicular to an axis through the hole, and
wherein the contact surface of the reinforcing element overall converges towards the crank arm, and the contact surface of the crank arm overall diverges towards the reinforcing element.

54. A bicycle crank arm assembly comprising:
a crank arm comprising
a first end for coupling with a bottom bracket assembly, and
a second end for coupling with a pedal, at least one of said first end and said second end defining a hole extending from a side of the crank arm for coupling with an axle of the pedal or of the bottom bracket assembly, respectively; and
a reinforcing element extending around said hole at said side of the crank arm, and fixed to the crank arm by caulking.

55. A bicycle crank arm assembly comprising:
a crank arm comprising
a first end for coupling with a bottom bracket assembly, and
a second end for coupling with a pedal, at least one of said first end and said second end defining a hole extending from a side of the crank arm for coupling with an axle of the pedal or of the bottom bracket assembly, respectively; and
a reinforcing element extending around said hole at said side of the crank arm, and fixed to the crank arm by gluing.
